(19) United States
(12) Patent Application Publication
(10) Pub. No.: US 2023/0266140 A1
(43) Pub. Date: Aug. 24, 2023

(54) MOBILITY ASSISTANCE DEVICE AND METHOD OF PROVIDING MOBILITY ASSISTANCE

(71) Applicant: THEIA GUIDANCE SYSTEMS LIMITED, Whitchurch (GB)

(72) Inventor: Anthony Dominic Camu, London (GB)

(21) Appl. No.: 18/043,622

(22) PCT Filed: Sep. 3, 2021
(86) PCT No.: PCT/IB2021/058058

§ 371 Date: Mar. 1, 2023

(30) Foreign Application Priority Data
Sep. 3, 2020 (GB) 2013876.4

(51) Int. Cl. G01C 21/36; G01C 21/28

(52) U.S. Cl. CPC G01C 21/3652; G01C 21/28

(57) ABSTRACT

Disclosed is a mobility assistance device and method of providing mobility assistance to a user. The device comprises a housing, a sensor arrangement, a tracking means for tracking a position and an orientation of the device, a processing arrangement configured to receive an input relating to a destination of a user of the device, receive the information relating to the environment from the sensor arrangement, compute a three-dimensional model of the environment based on information relating to the environment from the sensor arrangement, receive a current position and a current orientation of the device from the tracking means, determine an optimal route for reaching the destination starting from the current position of the device and compute a sequence of navigational commands for the optimal route, and a force feedback means configured to execute one or more actions to communicate the navigational commands to the user, wherein the one or more actions assist the user in traversing the optimal route. Specifically, the optimal route is determined by a sequence of navigational commands, wherein the navigational command is determined as a combination of directional commands relating to the optimal route, and commands specific to a current environment of the device, and wherein the directional commands are determined using a conventional satellite navigation system, and wherein the mobility assistance device is a handheld device.

### TECHNICAL FIELD

The present disclosure relates generally to orientation and mobility devices; and more specifically, to mobility assistance devices and methods of providing mobility assistance to a user, for example providing navigational assistance to the user.

### BACKGROUND

Over 253 million people are estimated to be visually impaired or blind worldwide, of which 36 million people are blind, and 217 million people suffer from moderate to severe visual impairment (MSVI). United Nations data predicts the global population will increase to 9.7 billion by 2050 and an even greater relative increase in the numbers of people aged over 80 is expected. Overall, there may be some 703 million people who are blind or have MSVI by the year 2050. Traditionally, the visually impaired have depended on guide dogs, canes, audible traffic signals and braille signs to navigate. However, without Orientation and Mobility training (O&M), it is extremely difficult for blind people to navigate through and understand their surroundings. Even with training, visually impaired people are confined to routes and places they are familiar with and must be constantly alert to sense cues, build a cognitive model of space and understand their routes in extreme detail.

Whether totally blind or with impaired vision, the visually impaired face significant challenges when moving around and interacting with their surroundings. Notably, wayfinding is a particular issue that prevents blind or visually impaired people from engaging in typical activities, such as socialising or shopping. Currently, guide dogs are the most effective aid for the blind and visually impaired as they allow individuals to traverse routes significantly faster than those with the traditional white cane. However, a vast majority of the blind and visually impaired community are unable to house an animal, due to issues such as long waiting lists, busy lifestyles, allergies, house size and/or expenses. As a result, millions of blind and visually impaired users rely on mobility equipment which does not come close to matching the utility of a guide dog. The problem is further widened by a diverse range of abilities within the visually impaired community as there is a spectrum of sight loss and each condition is individual to the user.

In recent times, there have been many solutions which attempt to improve the wayfinding experience for visually impaired people, although most of these have not been adopted by the blind community as they do not consider the variabilities between people of different physical and mental abilities. Furthermore, walking with a cane is an intensely focused task, with the user having to take into account every bit of useful detail from the rustling of a person's jacket to the texture of the pavement. The most widely used sensor technologies for assistive devices for the visually impaired are ultrasound sensors. Many smart canes, for example, usually feature ultrasonic sensors which vibrate when objects, such as low hanging trees, traffic signs and objects are near. However, these include a feedback system which often lacks intuition and is not well considered. Conventional solutions aim to extend senses for the user to provide them a better idea of the environment. However, this can further disorientate and confuse the user. Correspondingly, it is difficult to communicate the 3D environment through haptic signals which are usually transmitted through flat/planar areas on the skin or through clothing. Furthermore, prompting provided in this manner still requires the user to visualise a cognitive model of the surroundings, this slowing down visually impaired people while they try to walk through an environment. Notably, decisions during walking have to take place in a fraction of a second and in the case of a sighted person are usually automatic.

Therefore, in light of the foregoing discussion, there exists a need to overcome the aforementioned drawbacks associated with conventional methods for providing assistance to the visually impaired.

### SUMMARY

The present disclosure seeks to provide a mobility assistance device. The present disclosure also seeks to provide a method of providing mobility assistance to a user of the device. The present disclosure seeks to provide a solution to the existing problem of complicated operation and inadequacy of conventional assistance devices. An aim of the present disclosure is to provide a solution that overcomes at least partially the problems encountered in prior art, and provides an intelligent, intuitive assistance device that is suitable for use by people with all types of visual disabilities.

In one aspect, the present disclosure provides a mobility assistance device comprising
a housing;
a sensor arrangement;
a tracking means for tracking a position and an orientation of the device;
a processing arrangement configured to
   receive an input relating to a destination of a user of the device,
   receive the information relating to the environment from the sensor arrangement,
   compute a three-dimensional model of the environment based on information relating to the environment from the sensor arrangement,
   receive a current position and a current orientation of the device from the tracking means,
   determine an optimal route for reaching the destination starting from the current position of the device, and
   compute a sequence of navigational commands for the optimal route; and
a force feedback means configured to execute one or more actions to communicate the navigational commands to the user, wherein the one or more actions assist the user in traversing the optimal route,
   wherein the optimal route is determined by a sequence of navigational commands, wherein the navigational command is determined as a combination of directional commands relating to the optimal route, and commands specific to a current environment of the device, and wherein the directional commands are determined using a conventional satellite navigation system, and wherein the mobility assistance device is a handheld device.

In another aspect, the present disclosure provides a method of providing mobility assistance to a user using the device of any of the preceding claims, the method comprising
receiving an input relating to a destination of the user;
receiving information relating to an environment in which the device is being used;
computing a three-dimensional model of the environment based on information relating to the environment;
receiving a current position and a current orientation of the device;
determining an optimal route for reaching the destination starting from the current position of the device;
computing a sequence of navigational commands for the optimal route; and
executing one or more actions, via the device, to communicate the navigational commands to the user, wherein the one or more actions assist the user in traversing the optimal route, wherein the optimal route is determined by a sequence of navigational commands, wherein the navigational command is determined as a combination of directional commands relating to the optimal route, and commands specific to a current environment of the device, and wherein the directional commands are determined using a conventional satellite navigation system.

Embodiments of the present disclosure substantially eliminate or at least partially address the aforementioned problems in the prior art, and enable assistance for navigation that has a similar level of orientation and mobility only previously provided by guide dogs.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a mobility assistance device, in accordance with an embodiment of the present disclosure;

FIG. 2 is a perspective view of a mobility assistance device, in accordance with an embodiment of the present disclosure;

FIG. 3 is a cross-sectional side view of the mobility assistance device, in accordance with an embodiment of the present disclosure;

FIG. 4 is an exploded view of a gyroscopic assembly, in accordance with an embodiment of the present disclosure; and

FIG. 5 is a flowchart depicting steps of a method of providing mobility assistance to a user, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, the present disclosure provides a mobility assistance device comprising
a housing;
a sensor arrangement;
a tracking means for tracking a position and an orientation of the device;
a processing arrangement configured to
   receive an input relating to a destination of a user of the device,
   receive the information relating to the environment from the sensor arrangement,
   compute a three-dimensional model of the environment based on information relating to the environment from the sensor arrangement,
   receive a current position and a current orientation of the device from the tracking means,
   determine an optimal route for reaching the destination starting from the current position of the device, and
   compute a sequence of navigational commands for the optimal route; and
a force feedback means configured to execute one or more actions to communicate the navigational commands to the user, wherein the one or more actions assist the user in traversing the optimal route,
   wherein the optimal route is determined by a sequence of navigational commands, wherein the navigational command is determined as a combination of directional commands relating to the optimal route, and commands specific to a current environment of the device, and wherein the directional commands are determined using a conventional satellite navigation system, and wherein the mobility assistance device is a handheld device.

In another aspect, the present disclosure provides a method of providing mobility assistance to a user using the device of any of the preceding claims, the method comprising
receiving an input relating to a destination of the user;
receiving information relating to an environment in which the device is being used;
computing a three-dimensional model of the environment based on information relating to the environment;
receiving a current position and a current orientation of the device;
determining an optimal route for reaching the destination starting from the current position of the device;
computing a sequence of navigational commands for the optimal route; and
executing one or more actions, via the device, to communicate the navigational commands to the user, wherein the one or more actions assist the user in traversing the optimal route, wherein the optimal route is determined by a sequence of navigational commands, wherein the navigational command is determined as a combination of directional commands relating to the optimal route, and commands specific to a current environment of the device, and wherein the directional commands are determined using a conventional satellite navigation system.

The device and the method of the present disclosure aims to provide an assistance for navigation that has a similar level of orientation and mobility only previously provided by guide dogs. The mobility assistance device drastically reduces the mental and physical effort conventionally required for mobility aids by automating the tasks of the human visual system and mental tasks associated with walking. The present disclosure enables a high-fidelity physical feedback system that mainly provides guiding assistance to the user instead of providing prompts or alerts to the user. Notably, as the user walks along a route, the device determines appropriate trajectories and speeds to avoid oncoming obstacles or hazards, adheres to a predetermined route and communicates this through guiding directional forces. The force feedback means of the present disclosure can adapt with respect to various diverse orientation and mobility scenarios that would otherwise take more time to navigate. Notably, the processing arrangement does not merely convert environmental information into tactile signals but manages several walking decisions that were conventionally made by the user to provide a comfortable and intuitive walking experience to the user. Furthermore, the device only requires use of one hand of the user and thus the device can be used in a standing position or whilst seated in a wheelchair, for example in an electronic wheelchair. The mobility assistance device can further assist in tackling specific interactions for different types of terrain such as elevators, stairways, doorways, pedestrian crossings and so forth. The mobility assistance device may be employed in local or long-distance navigation and leverages real-time data relating to weather, traffic and the like, to guide users safely and efficiently. Furthermore, the device is compact, portable, light-weight and comfortable to use for prolonged periods of time. Furthermore, the device disclosed in the present disclosure provides different modes of functionality depending on the situation to ensure the user has awareness and control when a risk factor of the environment around the user increases.

Advantageously, the device pursuant to embodiments of the present disclosure, works in “autonomous mode” when there is a trackable and/or mapped optimal route available. In a situation, where a route is unavailable, the device provides a more “manual” experience (“3D cane mode”) in the form of communicating environmental information through force-feedback.

In an exemplary embodiment, as a user gets closer to an obstacle, the device induces a stronger force into the users' hand/forearm at a vector determined by the spatial deviation between the person and the obstacle. In another mode, users can scan the device from side to side to familiarise themselves with the environment much like a standard long cane, and feel nodes in space communicated by means of, for example, pulses of force-feedback, relating to obstacles/topography (e.g. lamp posts, steps) and/or the position of the optimal route—similar to Augmented Reality (AR). Further, if the path becomes available, users may be either forced back into autonomous mode to follow the optimal route or may enter into this mode by for example maintaining the devices spatial orientation within a spatial node to feel, as it were, “force pockets”.

Pursuant to embodiments of the present disclosure, the mobility assistance device is intended to be used by people with disabilities, specifically people with moderate to severe visual impairment. Notably, the mobility assistance device is designed as a replacement for conventional assistance methods such as a white cane or a guide dog. The mobility assistance device, by way of one or more actions executed thereby, leads the user of the device along a route while avoiding obstacles ensuring that the user walks in a straight line when necessary, aids in orientation referencing and ensures route adherence. For the sake of brevity, hereinafter the term “mobility assistance device” is used interchangeably with the term “device”.

Although mainly intended for use by the visually impaired, the device and method provided in the present disclosure should not be considered limited thereto. Notably, in virtual reality applications or in gaming, the device may simulate forces acting on a player. Furthermore, the device could be used to help normal people navigate through darkness or provide navigational assistance to another user at a distance. For example, a user holding the device will be able to interpret directional commands (e.g. suggested walking manoeuvres) in real time from a person operating the device from a distance. Moreover, the device may be used as a tool to communicate navigational commands such as directions and walking pace, in an art exhibition, a museum, during hikes, in blind running or skiing, or optionally, may be used for mobility rehabilitation.

The device comprises a housing. Herein, the term “housing” refers to a protective covering encasing the components (namely, the sensor arrangement, the tracking means, the processing arrangement, the force feedback means) of the mobility assistance device. Notably, the housing is fabricated to protect the components of the device from damage that may be caused due to falling, bumping, or any such impact to the device. Examples of materials used to manufacture the housing include, but are not limited to, polymers (such as polyvinyl chloride, high density polyethylene, polypropylene, polycarbonate), metals and their alloys (such as aluminium, steel, copper), non-metals (such as carbon fibre, toughened glass) or any combination thereof. It will be appreciated that the housing is ergonomically designed to allow comfortable grip of the user for prolonged periods of time, allowing maximum range of movement between a supination and pronation grip.

The device comprises a sensor arrangement for determining information relating to an environment in which the device is being used. It is to be understood that the environment in which the device is being used is the same as the environment surrounding the user of the device, as the device is handheld by the user. Therefore, the information relating to the environment provides insight into various factors that have to be taken into account prior to providing navigational commands to the user. Specifically, information relating to the environment provides an estimate of topography of the area surrounding the user that has to be navigated using the navigational commands provided by the device. The information relating to the environment includes, but is not limited to, distance between physical objects in the environment and the device, one or more images of the environment, degree of motion in the environment, audio capture and noise information of the environment.

Throughout the present disclosure, the term “sensor arrangement” refers to an arrangement of one or more sensors, and peripheral components required for operation of the sensors and transmittance or communication of the data captured by the sensors. Herein, a sensor is a device that detects signals, stimuli or changes in quantitative and/or qualitative features of a given environment and provides a corresponding output.

Optionally, the sensor arrangement comprises at least one of: a time-of-flight camera, an RGB camera, an ultrasonic sensor, an infrared sensor, a microphone array, a hall-effect sensor. The time-of-flight camera is a range imaging camera system that employs time-of-flight techniques to resolve distance between the camera (i.e. the device) and the subject for each point of the image, by measuring the round-trip time of an artificial light signal provided by a laser or an LED. Herein, the time-of-flight camera is employed to calculate distance between physical objects in the environment and the device. The time-of-flight cameras employ principles of depth sensing and imaging to calculate such distance. The RGB camera, or the Red Green Blue (RGB) camera refers to a conventional camera with a standard CMOS sensor using which coloured images of the environment can be captured. Notably, the captured coloured images of the environment provide insight into environmental parameters such as topography, number of obstacles or barriers in the environment, a type of environment (such as indoors, outdoors, street, parking space and the like), and so forth. Similar to the time-of-flight camera, the ultrasonic sensor provides information relating distance between physical objects in the environment and the device. The infrared sensor, or broadly, a thermographic camera, uses infrared radiation to generate images of the environment. Notably, such images provide information relating to the distance of the object and provide an estimate of the degree of motion in the environment. The microphone array refers to a configuration of a plurality of microphones that operate simultaneously to capture sound in the environment. Notably, the microphone array may capture far-field speech in the environment and optionally, a voice input from the user of the device.

The device comprises a tracking means for tracking a position and an orientation of the device. It will be appreciated that to accurately provide navigational commands to the user, via the device, the position and orientation of the device is to be known at all times, in order to execute one or more actions based on current position and current orientation of the device. Herein, the term “position” refers to a geographical location at which the device is located. Notably, since the device is handheld by the user, the position of the device is the same as the position of the user. Furthermore, the position may also include an elevation or altitude of the device with respect to the ground level, for example when the device and the person are on a higher floor of a building. Herein, the term “orientation” refers to a three-dimensional positioning of the device. In particular, the orientation provides information relating to a positioning of the device with respect to x-, y-, and z-axis in a three-dimensional space. In other words, the orientation of the device, when handheld by the user, may be described as analogous to principal axes of an aircraft, wherein the device is capable of rotation in three dimensions, namely, a yaw (left or right), a pitch (up or down) and a roll (clockwise or counter-clockwise). It will be appreciated that a movement of the device along any one of the axes as described above is indicative of a specific navigational command. For example, a movement of the device along the yaw axis may indicate the user to turn left or right; a movement of the device along the pitch axis may indicate the user to increase or decrease walking speed; and a movement of the device along the roll axis may indicate to the user to turn clockwise or counter-clockwise. Herein, the tracking means tracks (namely, determines) the position and the orientation of the device.

In an embodiment, the tracking means comprises at least one of: a satellite navigation device, an inertial measurement unit, a dead reckoning unit. The satellite navigation device, such as a Global Positioning System (GPS) receiver, is a device configured to receive information from global navigation satellite systems (GNSS) to determine the geographical location of the device. Such navigation devices are well known in the art. The inertial measurement unit is an electronic device employing a combination of accelerometers, gyroscopes and optionally, magnetometers, used to determine the orientation of the device in a three-dimensional space. Furthermore, the inertial measurement unit assists in determination of the geographical location in an event when satellite signals are unavailable or weak. The inertial measurement unit uses raw IMU data to calculate attitude, linear velocity and position of the device relative to a global reference frame. Furthermore, the dead reckoning unit is employed in an event when the satellite signals to the satellite navigation device are unavailable. The dead reckoning unit determines a current position of the device based on a last known position of the device, historical movement data of the user of the device and an estimated predicted movement trajectory of the user. Generally, the dead reckoning unit comprises a processor configured to perform such calculations, that functions in communication with the satellite navigation device and the inertial measurement unit.

In a specific embodiment, the mobility assistance device uses its GPS receiver(s) to receive information from GPS satellites and calculate the device's geographical position. In addition, RTK GNNS, camera(s), depth sensors and IMU(s) may be used to achieve centimeter level accuracy. Using suitable software, the device is communicatively coupled to an external device, such as a user's device (e.g., mobile phone), which may display the device's position on a digital map, and a user's device and/or the processing arrangement and/or a remote computer may calculate an initial optimal route between a user's origin and their desired destination. Optionally, user related data may be transferred via a wireless network connection (e.g., by a network connection such as 4G long-term evolution, LIE, network), to a server, including data such as latitude, longitude, altitude, geocode, course, direction, heading, speed, universal time (UTC), date, image/depth data, and/or various other information/data. Optionally, the device is configured to communicate with remote servers/external processing unit(s) (e.g., a cloud-based server or a server located in a remote facility) equipped with AI capabilities, including, for example, neural networks and/or machine learning which may optimize routes within, for example, digital maps to achieve, for example static and/or dynamic obstacle avoidance, quicker journey times, and user specific preferences.

Further, digital maps may be updated continuously with various information (e.g. locations of static/dynamic obstacles) based on user gathered data, such that a map of the location including associated data can be generated based on the user gathered data. Further, the device's memory may store, for example, map information or data to help locate and provide navigation commands to the user. The map data, which may include a network of optimal routes, may be preloaded and/or downloaded wirelessly through the tracking means. Optionally, the map data may be abstract, such as a network diagram with edges, or a series of coordinates with features. Optionally, the map data may contain points of interest to the user, and as the user walks, the cameras may passively recognize additional points of interest (e.g. shops, restaurants) and update the map data. Optionally, users may input, for example, points of interest, or navigation specific data (e.g. stopping at intersections) when they reach specific locations, and/or device orientations taken by the user. Further, the route of the user may be optimized by employing machine learning.

It is appreciated that the device and system may employ an interactive human/robot collision avoidance system, through which navigational commands and information relating to the environment (e.g. size and distance from obstacles) are communicated simultaneously through the same channel of feedback: for example if the user approaches a wall, the sensor arrangement will detect the walls proximity, the processing arrangement will then generate appropriate commands, using for example a 3D perception algorithm, and the processing arrangement will communicate such commands by means of force feedback, which will result in the generation of a directional force/torque into the users hand directly pursuant to the deviation between the distance/angle of the user and the obstacle, whilst still guiding the user along the optimal path. Critically, this ensures users are able to critique the device's navigation in real time without the use of an additional mobility aid, such as guide dogs or long canes, providing advantages over prior art specifically in safety and usability.

It will be appreciated that the use of the GPS and inertial odometry navigation will provide real-time guidance with situational awareness. The real-time guidance with situational awareness facilitates easy guiding for the user along predetermined routes whilst simultaneously understanding the environment they are passing through. Further, tracking and relaying of the user's routes with real-time odometry estimation by using deep sensor fusion of LiDAR, cameras, IMU with map navigation is failsafe, such that the device ensures users do not get lost in space and can autonomously avoid static obstacles, whereas users are primarily responsible for avoiding dynamic obstacles at the moment.

The device comprises a processing arrangement. As used herein, the processing arrangement may include, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processing arrangement may refer to one or more individual processors, processing devices and various elements associated with a processing device that may be shared by other processing devices. The processing arrangement is arranged within the housing of the device. The processing arrangement comprises a memory. Furthermore, the device comprises a transceiver communicably coupled to the processing arrangement, wherein the transceiver is configured to enable data communication of the processing arrangement with one or more external devices, using one or more data communication networks. Such data communication networks include, but are not limited to, Local Area Networks (LANs), Wide Area Networks (WANs), Metropolitan Area Networks (MANs), the Internet, radio networks (such as Bluetooth®, NFC®), telecommunication networks.

Optionally, the processing arrangement is communicably coupled to an external cloud-based processing unit via the data communication network. Notably, the external cloud-based processing unit may perform computationally intensive tasks after receiving instructions from the processing arrangement and communicate the output to the processing arrangement. It will be appreciated that offloading tasks that involve intensive computational load to the external cloud-based processing unit enables use of a simpler processing arrangement in the device, thereby reducing size thereof. Such a compact processing arrangement does not add significant weight to the device, thereby ensuring that the device is lightweight.

The processing arrangement is configured to receive an input relating to a destination of a user of the device. Herein, the term “destination” refers to a geographical location relating to which navigational commands are to be provided to the user of the device. It will be appreciated that the destination may be received as an input from the user in real-time, or may be pre-programmed in the processing arrangement, or may be received by the processing arrangement from a remote location and the like. Optionally, the device is provided with a microphone to receive voice inputs relating to the destination from the user of the device.

In an embodiment, the mobility assistance device comprises a display and a keypad. Alternatively, or additionally, the device comprises a touchpad. Notably, the display and the keypad and/or the touchpad provide an interface which enables the user of the device to provide the input relating to the destination to the processing arrangement.

In another embodiment, the mobility assistance device is communicably coupled to a portable electronic device, wherein the portable electronic device is implemented as an input device to provide inputs to the mobility assistance device and specifically, the processing arrangement. Herein, the term “portable electronic device” refers to an electronic device associated with (or used by) a user that is capable of enabling the user (or, another person) to perform specific tasks associated with the aforementioned mobility assistance device. Examples of portable electronic devices include, but are not limited to, cellular phones, personal digital assistants (PDAs), handheld devices, laptop computers, personal computers, etc. The portable electronic device is intended to be broadly interpreted to include any electronic device that may be used for data communication with the device over a wired or wireless communication network. Beneficially, the portable electronic device provides a sophisticated user-interface to the user for providing the input, thereby ensuring a hassle-free experience. It will be appreciated that another person, authorised by the user, may use the portable electronic device to provide inputs to the mobility assistance device. Optionally, the mobility assistance device may be configured to receive inputs from multiple portable electronic devices, enabling self-operation of the device along with an assisted operation thereof.

The processing arrangement is configured to receive the information relating to the environment from the sensor arrangement. Furthermore, the processing arrangement is configured to receive a current position and a current orientation of the device from the tracking means. Notably, the processing arrangement is communicably coupled to the sensor arrangement and the tracking means. It will be appreciated that the sensor arrangement and the tracking means are configured to continuously provide information relating to the environment and the position and orientation of the device respectively, in real-time or near real-time. Such continuous and updated details relating to the device enables the processing arrangement to control and monitor operation of the device in real time and ensure that the device is providing accurate navigational commands to the user. Furthermore, in an event if the user does not adhere to the navigational commands provided, the real time information relating to the operation of the device and the environment around it allows the processing arrangement to course correct, update the sequence of navigational commands, and provide the updated navigational commands via the force feedback means.

The processing arrangement is configured to determine an optimal route for reaching the destination starting from the current position of the device. Specifically, such an optimal route is determined based on the current position of the device. Hereinafter, the current position of the device starting from which the optimal route to the destination is determined is referred as “origin”. Herein, the term “optimal route” refers to a route between the origin and the destination having at least one of the properties: shortest distance, least number of turns, least number of obstacles, lowest foot and/or vehicular traffic, high density of sidewalks or pedestrian pathways, based on a preference of the user. In an instance, when the device is employed for mobility assistance of the visually impaired, the optimal route may be highly accessible for the disabled such as a route having a high number of tactile paved sidewalks, auditory traffic signals and so forth. Notably, the processing arrangement may identify multiple routes between the origin and the destination using conventional techniques of route mapping. Consequently, the processing arrangement may assign a weightage to each of the properties and assess each of the plurality of routes available to assign a weighted score to each of the routes based on their properties and determine the optimal route between the origin and the destination.

The processing arrangement is configured to compute a sequence of navigational commands for the optimal route. Notably, the navigational commands relate to directional commands (namely, instructions) that are to be provided to the user to assist the user in traversing a given route. For example, the navigational commands may include instructions relating to walking speed, directional information (such as relating to turning along a route, stopping at a road crossing), incoming obstacles (such as other pedestrians, traffic signals, intersections, crosswalks, automobiles), changing terrain (such as elevation, speed bumps, uphill or downhill terrain, stairs) and so forth. It will be appreciated that the processing arrangement takes into consideration a plurality of elements that are to be considered while walking along a given route and computes navigational commands relating to each of those elements.

It will be appreciated that the sequence of navigational commands for the optimal route are determined as a combination of directional commands relating to the optimal route and commands specific to a current environment of the user. Specifically, the directional commands include general instructions for travelling the optimal route such as instructions relating to paths, turns, crosswalks, changing terrains and the like. The directional commands relate to providing instructions for navigating stationary things that do not change over short periods of time. Notably, the directional commands are determined using conventional satellite navigation systems. The commands specific to the current environment of the user relate to instructions for navigating dynamic objects such as moving obstacles (such as pedestrians, automobiles, changing traffic signals and the like). The commands specific to the current environment further cater to providing instructions relating to obstacles that are not accounted for by the satellite navigation systems such as roadblocks, barricades, trees, and the like. It is to be understood that since such commands are based on the current environment of the user, they have to be computed in real-time or near real-time and provided to the user. As mentioned previously, the sensor arrangement provides information relating to the environment continuously and in real time. Therefore, based on the current environment of the user, the processing arrangement computes navigational commands relating to the current environment of the user in real-time or near real-time and communicates to the user, via the force feedback means.

Optionally, the processing arrangement is configured to compute a three-dimensional model of the environment based on information relating to the environment from the sensor arrangement. Notably, the processing arrangement employs information relating to the environment received from the sensor arrangement to construct the three-dimensional model of the environment. The processing arrangement analyses data from at least one of the: RGB camera, time-of-flight camera, infrared sensor, ultrasonic sensor to identify various attributes of the environment in which the device is being used. For example, the processing arrangement may employ computer vision to perform edge detection on the images obtained from the RGB camera to identify one or more obstacles in a predicted path of the user. Consequently, a distance of each of the obstacles from the device may be determined using depth sensing from the time-of-flight camera. Additionally, using the computer vision, any changes in the ground level may be identified. Upon computing the three-dimensional model of the environment, the processing arrangement may compute one or more navigational commands to notify the user of any incoming obstacle or change in topography.

Optionally, the processing arrangement employs machine learning algorithms. In an instance, the processing arrangement employs machine learning algorithms, or specifically artificial intelligence and neural networks to determine the optimal route to the destination. Additionally, the processing arrangement employs machine learning algorithms to compute the sequence of navigational commands. The machine learning algorithms enable the processing arrangement to become more accurate in predicting outcomes and/or performing tasks, without being explicitly programmed. Specifically, the machine learning algorithms are employed to artificially train the processing arrangement so as to enable them to automatically learn and improve performance from experience, without being explicitly programmed. Optionally, the processing arrangement may prompt the user to provide a feedback relating to the navigational commands provided via one or more actions of the force feedback means and may improve based on the feedback received from the user.

Optionally, the processing arrangement, employing the machine learning algorithms, is trained using a training dataset. Typically, examples of the different types of machine learning algorithms, depending upon the training dataset employed for training the software application comprise, but are not limited to: supervised machine learning algorithms, unsupervised machine learning algorithms, semi-supervised learning algorithms, and reinforcement machine learning algorithms. Furthermore, the processing arrangement is trained by interpreting patterns in the training dataset and adjusting the machine learning algorithms accordingly to get a desired output. Examples of machine learning algorithms employed by the processing arrangement may include, but are not limited to: k-means clustering, k-NN, Dimensionality Reduction, Singular Value Decomposition, Distribution models, Hierarchical clustering, Mixture models, Principal Component Analysis, and autoencoders.

Optionally, the processing arrangement may employ localisation techniques such as GNNS, RTK-GNNS and so forth for improving accuracy of the GPS. Typically, GNNS enabled devices such as smart phones have an accuracy of a few metres. In an embodiment, the two dual-band receivers use navigation signals from all four Global Navigation Satellite Systems (GNSS), namely GPS, GLONASS, BeiDou, and Galileo. Specifically, by using two spatially separated antennas, the processing arrangement may determine the device's absolute position and obtain a measurement of orientation. Optionally, one dual band receiver may be used to obtain navigation signals from all four Global Navigation Satellite Systems (GNSS), namely GPS, GLONASS, BeiDou, and Galileo. Further, accuracy of GNNS may be improved with the use of Real-time kinematics (RTK) technology (allowing centimetre-level accurate positioning). Specifically, the RTK-GNNS sensor uses standard RTCM 10403 version 3 differential GNSS services correction data, and networked transport of RTCM data (NTRIP) is used to provide the data to the sensor. Furthermore, sensor data may be obtained from a Virtual Reference Station (VRS) network or from a local physical base-station. Also, cloud services may be used to assist data distribution.

It will be appreciated that despite the accuracy of RTK-GNNS, localization methods based on GNNS are susceptible to environmental conditions, (e.g. GNNS degrades between buildings, and GNNS fails under bridges or indoors), due to, for example, ionospheric activity, tropospheric activity, signal obstructions, multipath and radio interference.

Additionally, various odometry algorithms/methods may be fused to reduce system drift for reducing/eliminating the shortcomings of GNNS based navigation. Optionally, the processing arrangement may continuously monitor the GNSS operation and the RTK correction data stream. Further, the processing arrangement may use algorithms which assess the quality and reliability of both in order to obtain optimum performance under most circumstances.

It will be appreciated that a variety of the odometry algorithms/methods may be used for GPS denied localisation including radar, inertial, visual, laser and the like. Typically, odometry methods are fused to improve accuracy and robustness (e.g. radar inertial, visual radar, visual inertial, visual laser)

Optionally, the odometry algorithms/methods may include Visual Odometry, Inertial Odometry and/or Visual-Inertial Odometry (VIO).

Optionally, the Visual Odometry may be used to estimate the position and orientation of the device by analysing the variations induced by the motion of a camera on a sequence of images. VO techniques may be categorized based on the key information, position of the camera, and type/number of the camera. The key information, upon which odometry is performed, can be direct raw measurements, i.e., pixels, or indirect image features such as corners and edges or combination of them, i.e., hybrid information. The camera type/number can be monocular, stereo, RGB-D, omnidirectional, fisheye, or event-based. The camera pose, in turn, can be either forward-facing, downward facing, or hybrid.

Optionally, inertial odometry (IO), or an inertial navigation system (INS), may be used. Inertial odometry is a localisation method that uses the measurements from the IMU sensor to determine the position, orientation, altitude, and linear velocity of the device, relative to a given starting point. An IMU sensor is a micro-electro-mechanical system (MEMS) device that mainly consists of a 3-axis accelerometer and a 3-axis gyroscope. The accelerometer measures non-gravitational acceleration whereas the gyroscope measures orientation based on measurement of gravity and magnetism. Moreover, navigation systems based on IMUs do not require an external reference to accurately estimate the position of a platform. However, these systems suffer from a drifting issue due to errors originated from different sources e.g., constant errors in gyroscope measurements and accelerometers. These errors, later, lead to an increasing error in the estimated velocity and position. Different solutions may be used to help reduce this problem. For example, a probabilistic approach based on double-integration rotated acceleration using the extended Kalman filter framework (EKF) may be employed. Even with such improvements, inertial odometry is not capable enough to be used as the primary navigation method to allow autonomous navigation in GPS denied environments.

Optionally, the Visual-Inertial Odometry (VIO) is used for eliminating the limitations based on environmental conditions such as lighting, shadows, blur images, and frame drops. Additionally, the VIO may be fused with RTK-GNNS to improve system accuracy. Optionally, a loosely coupled combination may be considered. Further, the VIO may be categorized into two ways, based on how the visual and inertial data are fused: filter-based and optimization-based. Moreover, based on when the measurements are fused it can be categorized into loosely-coupled and tightly-coupled. Additionally, there are various camera setups, e.g., monocular, stereo, RGB-D, and omnidirectional cameras; and different methods to extract key information from captured images, such as feature-based, direct, and hybrid approaches. Further, the raw sensor outputs are fused in the processing arrangement to derive the optimal position and attitude estimate. In an alternative embodiment, GNSS observations, camera images and IMU measurements may all be incorporated into one optimization problem to find the most likely pose.

It will be appreciated that the main benefits of a tightly coupled fusion approach versus a loosely coupled combination or weighting of the individual sensors are strengths of different sensing technologies and are combined to alleviate weaknesses of the individual sensors. The accuracy and the precision of sensor measurements is incorporated into the optimization and improved stability and robustness due to inter-sensor prediction, such as IMU measurements. This can be used to predict visual features and camera observations help to form a prior for the GNSS estimation problem.

The mobility assistance device comprises the force feedback means configured to execute one or more actions to communicate the navigational commands to the user, wherein the one or more actions assist the user in traversing the optimal route. Herein, the term “force feedback means” refers to an arrangement of one or more mechanical actuation elements (such as, a control moment gyroscope) and sound-producing devices (such as, a speaker) that enable generation of a feedback in the mobility assistance device. Furthermore, the force feedback means manipulates orientation of the device to execute at least one of the one or more actions. Notably, the feedback generated by the force feedback means is a force feedback that applies a guiding force on a user's hand to provide navigational assistance to the user. Such force feedback further provides navigation assistance to the user by simulating an experience of touch and motion, analogous to an experience when using a guide dog for navigation. Optionally, in addition to the force feedback, the force feedback means generates a haptic feedback. It will be appreciated that each of the one or more actions executed by the force feedback means is associated with a specific navigational command. Specifically, when the force feedback means executes a given action, the user interprets and recognises the navigational command associated with that given action. Furthermore, the one or more actions are associated with the navigational commands in a manner that the user may intuitively recognise the navigational command when the action associated with it is executed by the force feedback means. Alternatively, a tutorial may be provided to the user prior to use of the device, wherein the tutorial enables the user to learn the navigational commands that are associated with each of the one or more actions.

In an embodiment, the one or more actions include at least one of: a directional force, an audio signal, a haptic vibration. Herein, the directional force is provided as one of the one or more actions by the force feedback means to communicate walking manoeuvres to the user by manipulating the movement of a user's hand, and/or inducing force onto it in specific ways. The directional force may be provided along one or more axes of the mobility assistance device. As mentioned previously, a directional force provided along the yaw axis and the roll axis may indicate a navigational command relating to a directional movement to the user whereas a directional force along the pitch axis may indicate a navigational command relating to a walking pace of the user. Furthermore, the haptic vibration may be provided as one of the one or more actions to communicate various navigational commands such as ‘start walking’, ‘stop walking’ and so forth. Additionally, haptic vibration may be used in combination with the directional force to provide navigational commands. Moreover, the nature of the haptic vibration, such as length of the vibration, pulsed vibration and the like, may be altered to communicate different navigational commands. In an instance, when complicated navigational commands are to be communicated to the user, the force feedback means may provide a speech output as an audio signal. Additionally, the audio signal may be a specific sound that could be associated with a navigational command. Complicated walking manoeuvres, such as ducking or going sideways, backwards or turning around, can be communicated to the user via a three-dimensional force feedback directed in any direction within a 360-degree sphere of movement. Notably, the audio signal may be provided using a speaker provided in the device, or via earphones communicably coupled to the device. In an example, the earphones may be bone-conduction earphones.

It will be appreciated that the device is adaptable to diverse situations that may arise in an environment and may enter different modes of functionality based on complexity and risk factor of an environment. For example, the processing arrangement may identify a busy environment, such as a crossroad, a traffic intersection, a traffic signal, and may enter a mode of reduced level of functionality. In such mode of reduced level of functionality, the device may be analogous to a walking cane and may not force the user to follow walking decisions determined thereby and instead may just prompt the user relating to incoming obstacles and assist them in understanding the environment. In another example, the processing arrangement may identify an approaching stairway and may induce a force onto the user's hand to indicate them to stop and subsequently may guide the user's hand towards a handrail of the stairway. In another example, the processing arrangement may identify that the user may need to use a button array (for example, button array of an elevator) and subsequently, may guide the user's hand towards a correct area on the button array. Similarly, the processing arrangement may guide the user's hand towards door handles.

In an embodiment, the force feedback means comprises a gyroscopic assembly configured to generate an angular momentum to induce a directional force in the device. Herein, the gyroscopic assembly is implemented in effect as an inertia wheel assembly. Such assembly consists of three circular rotors, such as wheels or disks, placed orthogonally in the x, y and z planes, which when spinning generate a torque individual to each axis. Consequently, a net rotational inertia of the assembly is controlled by control of individual spinning rotors of the assembly to provide the directional force. Notably, the three circular rotors substantially share a common centre of gravity. The three circular rotors function in effect like torque motors that are designed to produce the same amount of angular momentum and kinetic energy when spinning at the same angular velocity. Such coordination between the three circular rotors is achieved by a careful selection of materials based on their densities. Notably, the directional movement of the device provided by the gyroscopic assembly is regulated by controlling an angular momentum generated by acceleration or deceleration of the individual circular rotors, and/or by rotating the circular rotors in clockwise or counter-clockwise directions. Therefore, by manipulating levels of angular momentum along the three axes, the navigational commands relating to direction and walking pace can be communicated to the user. Notably, the gyroscopic assembly is housed within a frontal portion of the housing and is supported by ribs and bosses with the housing manufactured using injection moulding. It will be appreciated that the rotation of the circular rotors is achieved using a brushless electric motor design, such as a BLDC inrunner motor.

It will be appreciated that despite accurate manufacturing tolerances as required for fast spinning circular rotors, unwanted vibrations may occur. Therefore, to prevent the vibrations, dampening springs may hold the gyroscopic assembly within the housing. Beneficially, the gyroscopic assembly provides a significant advantage in that less mechanisms are required to change the direction of the angular momentum produced by the spinning mass and can provide torque in any possible direction. With respect to the gyroscopic assembly employed in the device of the present disclosure, each of the rotors employs an electromagnetic braking system to maximize the moment of inertia exhibited by the circular rotors. Notably, braking each of the three individual rotors allows a rapid exchange of angular momentum. Such change in angular momentum generates a significant amount of force in a relatively small space. Notably, the electromagnetic braking system may be employed to jerk the user's hand into a correct position when needed, for example when an obstacle is presented very quickly in front of the user. The three circular rotors can be braked either in quick succession or simultaneously, to move the user's hand in the correct direction with respect to x, y and z-axis.

Optionally, the gyroscopic assembly comprises circular rail enclosures enclosing each of the three circular rotors. Notably, each of the three circular rotors employ multiple high-speed bearings that move within the circular rail enclosures that are made of a lightweight material, such as Polytetrafluoroethylene (PTFE) or polyether ether ketone (PEEK), that has a low coefficient of friction and a high melting point, thereby allowing operation of the circular rotors at high temperatures. Furthermore, the gyroscopic assembly further comprises four electromagnets or drive coils secured onto each of the circular rail enclosures, that drive the rotors around the inside of the circular rail enclosures, allowing them to spin at very high angular velocities. The circular rail enclosures are used to contain and control mechanical spin of the circular rotors and are also the housing for the electromagnets or drive coils for the brushless electric motor design. Notably, each of the three circular rotors comprises multiple magnets (such as, six magnets) embedded in the circumference thereof, wherein the magnets are manufactured using neodymium. Herein, the circular rail enclosures comprise drive coils or electromagnets that are charged and used to rotate the three circular rotors using the magnets embedded in the rotors. Preferably, each of the circular rail enclosures has four electromagnets or drive coils that are spaced 90° apart, wherein the drive coils or electromagnets cooperate with rotor magnets to provide the propulsion for the circular rotors within the circular rail enclosures in a manner consistent with typical operation of a brushless electric motor design. Furthermore, a control circuit is employed to switch polarity of the drive coils or the electromagnets to attract or repel the magnets embedded in the circular rotors, thereby controlling speed and direction of spin of individual rotors. It will be appreciated that the housing comprises braille embossed buttons that can be used to remove the gyroscopic assembly from the housing. Subsequently, the circular rail enclosures containing the rotors can be disassembled by unbolting a series of nuts and bolts. Furthermore, copper drive coils wound around the circular rail enclosures are alternatively employed to drive the rotors.

Optionally, the sensor arrangement is further configured to measure an angular velocity of one or more rotors in the gyroscopic assembly. As mentioned previously, the sensor arrangement comprises hall sensors therein. Therefore, the hall sensors are used to measure the angular velocity of the three circular rotors in the gyroscopic assembly. As mentioned herein above, the drive coils or electromagnets are energized to attract or repel the magnets embedded in the rotors. Notably, the hall sensors are used to determine the position of the rotor and based on the determined position, an electronic controller energizing the drive coils or electromagnets is capable of determining which drive coil or electromagnet is to be energized. It will be appreciated that the processing arrangement is configured to provide instructions to the force feedback means and control operation thereof. Specifically, the processing arrangement controls the angular momentum provided by the gyroscopic assembly to control the directional force provided by the device. Therefore, to control the angular momentum, the angular velocity of each of the rotors is to be known. Notably, hall sensors are used to measure a magnitude of magnetic field and can detect any change therein. The hall sensors in the sensor arrangement measure the angular velocity of the rotors and communicate it to the processing arrangement. Beneficially, the sensor arrangement allows the processing arrangement to ensure that the device is in proper operating condition and is providing navigational commands accurately.

Optionally, the mobility assistance device uses an electrical battery for powering the processing arrangement, force feedback means and other components thereof. Notably, the electrical battery may be rechargeable. The housing may comprise a mechanical button thereon to remove the battery from the device.

Optionally, the mobility assistance device further comprises a signaling means configured to indicate a direction of movement of the user. Herein, the signaling means indicates a direction of movement of the user to incoming pedestrians or automobiles. The signaling means may comprise one or more LEDs (Light emitting diodes) installed at the frontal portion of the housing, wherein the LEDs may be illuminated based on a projected trajectory of the user to notify the incoming pedestrians. In an instance, the signaling means may comprise an array of LEDs implemented as a display board that may display arrows or signals indicating the direction of movement of the user.

Optionally, the mobility assistance device is integrated within a wearable device, such as gloves, smartwatch, and the like. Notably, such integration enhances ease of use of the device and eliminates a need of carrying an additional tool for navigation. Optionally, the device is modular, wherein the device can be attached to the wearable device.

The present disclosure also relates to the method as described above. Various embodiments and variants disclosed above apply mutatis mutandis to the method.

In another aspect, an embodiment of the present disclosure provides a mobility assistance device comprising
a housing;
a sensor arrangement for acquiring information relating to an environment in which the device is being used;
a tracking means for tracking a position and an orientation of the device;
a processing arrangement configured to
   receive an input relating to a targeted position of the device,
   receive the information relating to the environment from the sensor arrangement,
   receive a current position and a current orientation of the device from the tracking means,
   compute a sequence of navigational commands to situate the device in the targeted position; and
a force feedback means configured to execute one or more actions to situate the device in the targeted position.

In an exemplary embodiment, the input device including but not limited to touch sensor and/or one or more buttons—fingerprint recognition along with a display may be integrated into the device or wirelessly connected to the device and may be capable of displaying visual data from the stereo cameras and/or the camera. Further, the device may include—input/output port (I/O port) The I/O port and one or more ports for connecting additional periph-erals. For example, the I/O port may be a headphone jack or may be a data port. Furthermore, the device may connect to another device or network for data downloads, such as updates to the device, map information or other relevant information for a particular application, and data uploads, such as status updates and updated map information using the transceiver and/or the I/O port allows the device to communicate with other smart devices for distributed computing or sharing resources.

In an additional embodiment, the device's memory may store, for example, map information or data to help locate and provide navigation commands to the user. The map data may be preloaded, downloaded wirelessly through the transceiver, or may be visually determined, such as by capturing a building map posted near a building's entrance, or built from previous encounters and recordings. Further, the processor may search the memory to determine if a map is available within the memory. If a map is not available in the memory, the processor may, via the transceiver, search a remotely connected device and/or the cloud for a map of the new location. The map may include any type of location information, such as image data corresponding to a location, GPS coordinates or the like. Alternatively, the processor may create a map within the memory, the cloud and/or the remote device. The new map may be continuously updated as new data is detected, such that a map of the location including associated data can be generated based on the detected data.

In another embodiment, the device may include a light sensor for detecting an ambient light around the device. The processor may receive the detected ambient light from the light sensor and adjust the stereo cameras and/or the camera(s) based on the detected light, such as by adjusting the metering of the camera(s). Advantageously, this allows the camera(s) to detect image data in most lighting situations.

In various embodiments, the processor may be adapted to determine a status of the power supply. For example, the processor may be able to determine a remaining operational time of the device based on the current battery status.

The processing arrangement may receive the image data and determine whether a single object or person is selected. This determination may be made based on image data gathered from the sensor arrangement. For example, if the user is pointing at a person or holding an object, the processing arrangement may determine that the object or person is selected for labelling. Similarly, if a single object or person is in the field of view of the stereo camera and/or the camera, the processing arrangement may determine that that object or person has been selected for labelling. In some embodiments, the processing arrangement may determine what is to be labelled based on the user's verbal commands. For example, if the verbal command includes the name of an object that the processing arrangement has identified, the processing arrangement may know that the label is for that object. If the label includes a human name, the processing arrangement may determine that a human is to be labelled. Otherwise, the processing arrangement may determine that the current location is to be labelled. Additionally, if the user states the name of a location, such as “my workplace,” the processing arrangement may determine that the location is selected for labelling.

Additionally, the processor may determine a label for the object or person. The user may input the label via the input device or by speaking the label such that the device detects the label via the microphone. Further, the processor may store the image data associated with the object or person and the memory. The processor may also store the label in the memory and associate the label with the image data. In this way, image data associated with the object or person may be easily recalled from the memory because it is associated with the label. Furthermore, the processing arrangement may store the current position and the label in the memory. The processing arrangement may also associate the location with the label such that the location information may be retrieved from the memory using the label. In some embodiments, the location may be stored on a digital map. Furthermore, a request may be received from the user that includes a desired object, place, or person. This request may be a verbal command, such as “navigate to Julian's,” “where is Fred,” “take me to the exit,” or the like.

In another embodiment, the maps (e.g., HD maps) may be generated and periodically updated using data provided by one or more vehicles (e.g., autonomous vehicles) in addition to static and dynamic obstacle data provided by one or more users (e.g., via the device).

In various embodiments, the GPS receiver may be configured to use an LS frequency band (e.g., centered at approximately 117 6.45 MHz) for higher accuracy location determination (e.g., to pinpoint the device to within 30 centimeters or approximately one foot).

In yet another embodiment, the device may include a routing module. The routing module may include computer-executable instructions, code, or the like that responsive to execution by one or more of the processor(s) may perform one or more blocks of the process flows described herein and/or functions including, but not limited to, determine points of interest, determine historical user selections or preferences, determine optimal routing, deter-mine real-time traffic data, determine suggested routing options, send and receive data, control device features, and the like. Further, a routing module may be in communication with the device, third party server, user device, and/or other components. For example, the routing module may send route data to the device, receive traffic and obstacle information from the third-party server, receive user pref-erences, and so forth.

In an embodiment, the device may employ artificial intelligence to facilitate automating one or more features described herein e.g., performing object detection and/or recognition, determining optimal routes, providing instructions based on user preferences, and the like). The components can employ various AI-based schemes for carrying out various embodi-ments/examples disclosed herein. To provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide reasoning about or determine states of the system, environment, etc. from a set of observations as captured via events and/or data. Determinations can be employed to identify a specific context or action, or can generate a probability distribution over states, for example. The determinations can be proba-bilistic—that is, the computation of a probability distribu-tion over states of interest based on a consideration of data and events. Determinations can also refer to techniques employed for composing higher-level events from a set of events and/or data.

Such determinations can result in the construction of new events or actions from a set of observed events and/or stored event data, whether the events are correlated in close temporal proximity, and whether the events and data come from one or several event and data sources. Components disclosed herein can employ various classification (explicitly trained (e.g., via training data) as well as implicitly trained (e.g., via observing behaviour, preferences, historical information, receiving extrinsic information, etc.)) schemes and/or systems (e.g., support vector machines, neural net-works, expert systems, Bayesian belief networks, fuzzy logic, data fusion engines, etc.) in connection with perform-ing automatic and/or determined action in connection with the claimed subject matter. Thus, classification schemes and/or systems can be used to automatically learn and perform a number of functions, actions, and/or determina-tions.

In an alternate embodiment, the device may further include or be in communication with non-volatile media (also referred to as non-volatile storage, memory, memory storage, memory circuitry and/or similar terms used herein interchangeably). In one embodiment, the non-volatile stor-age or memory may include one or more non-volatile storage or memory media 310, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database mod-els, such as a hierarchical database model, network model, relational model, entity-relationship model, object model, document model, semantic model, graph model, and/or the like.

In one embodiment, the device may further include or be in communication with volatile media (also referred to as volatile storage, memory, memory storage, memory circuitry and/or similar terms used herein inter-changeably). In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, I-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing arrangement. Thus, the databases, database instances, database management systems, data, applications, programs, program mod-ules, scripts, source code, object code, byte code, compiled code, interpreted code, machine code, executable instruc-tions, and/or the like may be used to control certain aspects of the operation of the device with the assistance of the processing arrangement and operating system.

### DETAILED DESCRIPTION OF THE DRAWINGS

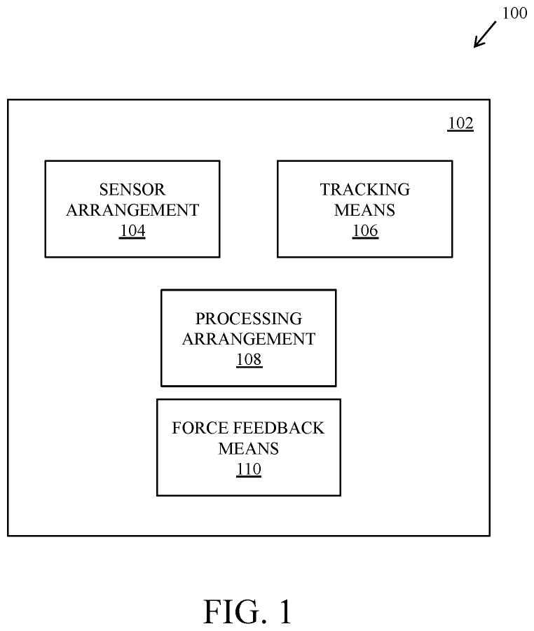

Referring to FIG. 1, illustrated is a block diagram of a mobility assistance device 100, in accordance with an embodiment of the present disclosure. The device 100 comprises a housing 102, a sensor arrangement 104, a tracking means 106, a processing arrangement 108 and a force feedback means 110. The sensor arrangement 104 acquires information relating to an environment in which the device 100 is being used. The tracking means 106 for tracking a position and an orientation of the device 100. The processing arrangement 108 is configured to receive an input relating to a destination of a user of the device 100, receive the information relating to the environment from the sensor arrangement 104, receive a current position and a current orientation of the device 100 from the tracking means 106, determine an optimal route for reaching the destination starting from the current position of the device 100, and compute a sequence of navigational commands for the optimal route. The force feedback means 110 configured to execute one or more actions to communicate the navigational commands to the user, wherein the one or more actions assist the user in traversing the optimal route.

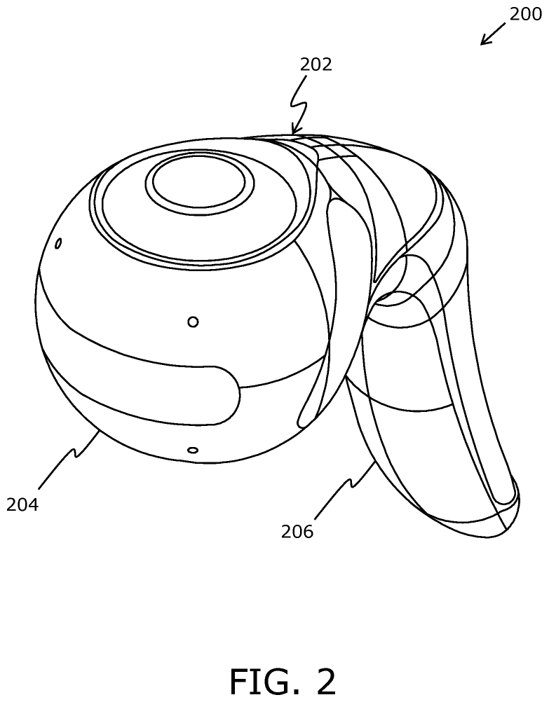

Referring to FIG. 2, illustrated is a perspective view of a mobility assistance device 200, in accordance with an embodiment of the present disclosure. The device 200 comprises a housing 202. Notably, a frontal portion 204 of the housing 202 substantially encases the components (namely, the sensor arrangement, the tracking means, the processing arrangement, the force feedback means) of the mobility assistance device 200. Furthermore, the housing 202 has a gripping portion 206 for allowing a user of the device 200 to hold the device 200 in his hand.

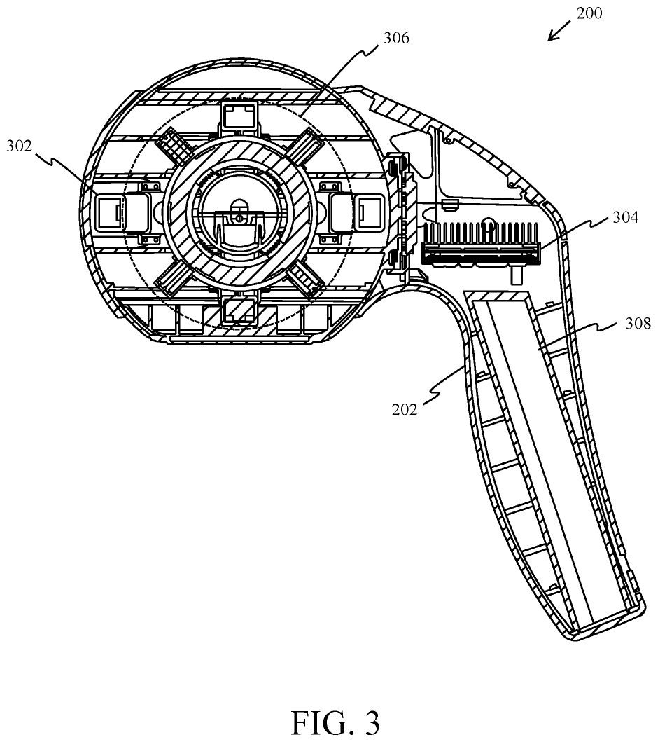

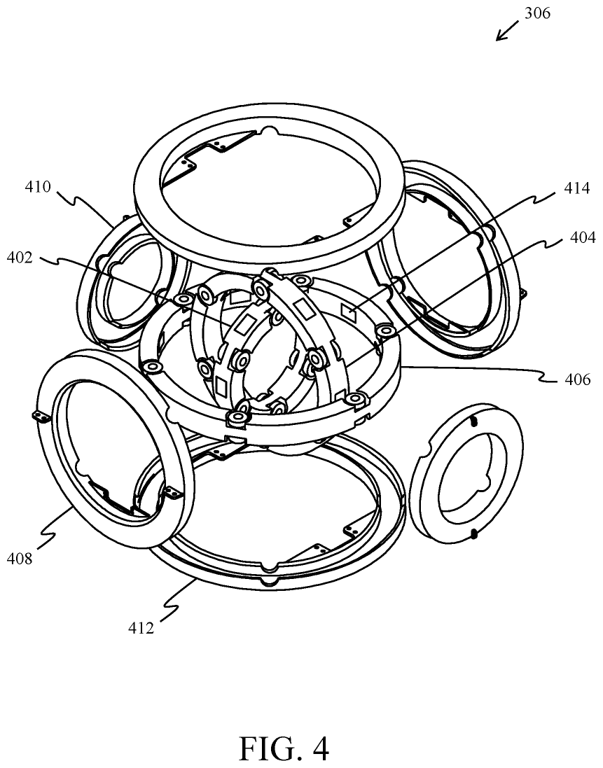

Referring to FIG. 3, illustrated is a cross-sectional side view of the mobility assistance device 200, in accordance with an embodiment of the present disclosure. As shown, the device 200 comprises the housing 202 for encasing the components of the device 202. The device 200 comprises a sensor arrangement 302 arranged in a frontal portion of the housing 202 and a tracking means (not shown). The device 200 further comprises a processing arrangement 304. Furthermore, the device 200 comprises a force feedback means comprising a gyroscopic assembly 306 configured to generate an angular momentum to induce a directional force in the device 200. The gyroscopic assembly 306 is explained in detail in FIG. 4. Moreover, the mobility assistance device 200 uses an electrical battery, insertable in battery compartment 308, for powering the processing arrangement 304, force feedback means and other components (such as the sensor arrangement 302 and the tracking means) thereof.

Referring to FIG. 4, illustrated is an exploded view of the gyroscopic assembly 306, in accordance with an embodiment of the present disclosure. As shown, the gyroscopic assembly 306 is implemented in effect as an inertia wheel assembly. The assembly 306 consists of three circular rotors, such as the rotors 402, 404 and 406, placed orthogonally in the x, y and z planes, which when spinning generate a torque individual to each axis. Notably, the three circular rotors 402, 404, 406 substantially share a common centre of gravity. The gyroscopic assembly 306 comprises circular rail enclosures, such as the enclosures 408, 410, 412, enclosing each of the three circular rotors 402, 404, 406. The mobility assistance device employs a brushless electric motor design to spin a magnetically patterned ring embedded within each of the three circular rotors 402, 404, 406. The magnetically patterned ring comprises multiple magnets embedded in the circumference of the rotors, such as the magnet 414 embedded in the circumference of the rotor 406.

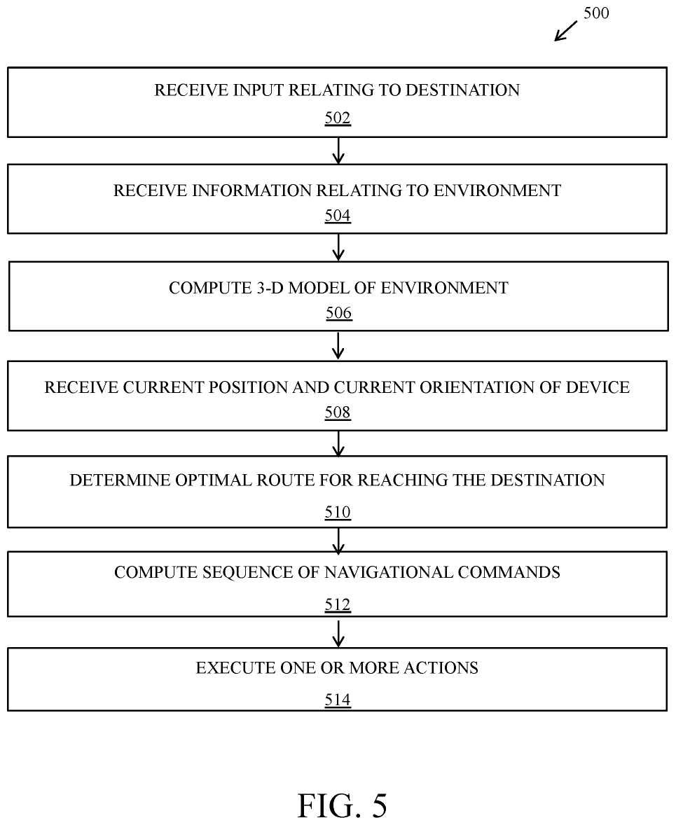

Referring to FIG. 5, illustrated is a flow chart 500 depicting steps of a method of providing mobility assistance to a user, in accordance with an embodiment of the present disclosure. At step 502, an input relating to a destination of the user is received. At step 504, information relating to an environment in which the device is being used is received. At step 506, a three-dimensional model of the environment based on information relating to the environment is captured. At step 508, a current position and a current orientation of the device (such as the device 100 of FIG. 1) is received. At step 510, an optimal route for reaching the destination starting from the current position of the device is determined. At step 512, a sequence of navigational commands for the optimal route is computed. At step 514, one or more actions are executed via the device to communicate the navigational commands to the user, wherein the one or more actions assist the user in traversing the optimal route.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1.-10. (canceled)

11. A mobility assistance device (100) comprising:
a housing (102);
a sensor arrangement (104);
a tracking means (106) for tracking a position and an orientation of the device;
a processing arrangement (108) configured to
receive an input relating to a destination of a user of the device (100),
receive the information relating to the environment from the sensor arrangement (104),
compute a three-dimensional model of the environment based on information relating to the environment from the sensor arrangement (104),
receive a current position and a current orientation of the device (100) from the tracking means (106),
determine an optimal route for reaching the destination starting from the current position of the device (100), and
compute a sequence of navigational commands for the optimal route;
a force feedback (110) means configured to execute one or more actions to communicate the navigational commands to the user, wherein the one or more actions assist the user in traversing the optimal route,
wherein the optimal route is determined by a sequence of navigational commands, wherein the navigational command is determined as a combination of directional commands relating to the optimal route, and commands specific to a current environment of the device (100), and wherein the directional commands are determined using a conventional satellite navigation system, and wherein the mobility assistance device (100) is a handheld device.

12. A device (100) according to claim 11, wherein the sensor arrangement (104) comprises at least one of: a time-of-flight camera, an RGB camera, an ultrasonic sensor, an infrared sensor, a microphone array, a hall-effect sensor.

13. A device (100) according to claim 11, wherein the tracking means (106) comprises at least one of: a satellite navigation device, an inertial measurement unit, a dead reckoning unit.

14. A device (100) according to claim 11, wherein the one or more actions include at least one of: a directional force, an audio signal, a haptic vibration.

15. A device (100) according to claim 11, wherein the force feedback means (110) comprises a gyroscopic assembly (306) configured to generate an angular momentum to induce a directional force in the device (100).

16. A device (100) according to claim 15, wherein the sensor arrangement is further configured to measure an angular velocity of one or more rotors (402) in the gyroscopic assembly (306).

17. A device (100) according to claim 11, further comprising a signalling means configured to indicate a direction of movement of the user to incoming pedestrians or automobiles.

18. A device according to claim 11, wherein the processing arrangement employs machine learning algorithms.

19. A device (100) according to claim 11, wherein the three-dimensional model of the environment is computed by analysing data from the sensor arrangement (104) to identify various attributes of the environment in which the device (100) is being used, wherein the processing arrangement (108) is further configured to perform edge detection on the images obtained from the RGB camera for obstacle identification and depth sensing on the images obtained from the time-of-flight camera for measuring the distance of the obstacle from the device (100).

20. A method of providing mobility assistance to a user using the device (100) of claim 11, the method comprising
receiving an input relating to a destination of the user;
receiving information relating to an environment in which the device is being used;
computing a three-dimensional model of the environment based on information relating to the environment;
receiving a current position and a current orientation of the device (100);
determining an optimal route for reaching the destination starting from the current position of the device (100);
computing a sequence of navigational commands for the optimal route; and
executing one or more actions, via the device (100), to communicate the navigational commands to the user, wherein the one or more actions assist the user in traversing the optimal route,
wherein the optimal route is determined by a sequence of navigational commands, wherein the navigational command is determined as a combination of directional commands relating to the optimal route, and commands specific to a current environment of the device (100), and wherein the directional commands are determined using a conventional satellite navigation system.
